(19) United States
(12) Patent Application Publication
(10) Pub. No.: US 2003/0233652 A1
(43) Pub. Date: Dec. 18, 2003

(54) Method and apparatus for intuitionally moving the focus within a window

(75) Inventor: Wenhao Hsieh, Taipei Hsien (TW)

Correspondence Address: BACON & THOMAS, PLLC, 625 SLATERS LANE, FOURTH FLOOR, ALEXANDRIA, VA, 22314

(73) Assignee: Kinpo Electronics, Inc.

(21) Appl. No.: 10/173,684

(22) Filed: Jun. 18, 2002

(51) Int. Cl. H04N 5/445; H04N 7/173

(52) U.S. Cl. 725/38; 725/100; 725/110

(57) ABSTRACT

A method and apparatus for moving the focus within a window, the focus movement can be performed on an information apparatus, such as a set top box (STB). The present invention enables a user to control the focus to move within a window via directional buttons. When a directional button is pressed, determining if there is a link along the direction of the directional button pressed by the user, if yes, then move the focus to the link. If there is no link, then further determine if there is any content. If yes, then scroll the active sub-window along the direction of the directional button. If there is no content, then further determine if there is a sub-window, if yes, then move the focus to the sub-window.

### BACKGROUND OF THE INVENTION

1. Field of the Invention

The present invention relates to a method and apparatus for intuitionally moving the focus within a window, more particularly, performing such movements on an information apparatus field such as set top box (STB).

2. Description of the Related Art

The conventional STB is connected to a television. A user can surf on the Internet via a network interface provided by the STB and watch TV programs via a TV tuner. The user can choose to watch TV or to surf on the Internet. The STB provides network connectivity, enabling the user to surf on the Internet without the need of a personal computer. The STB serves as a multi-function work platform, which is a great improvement for information devices.

The web page is designed as a window that may also be divided to a plurality of sub-windows. The window or sub-window usually has a plurality of links. The user can view other web pages by selecting a proper link. For example, the web page for providing news contains many links according to the news type, such as a sport news link, or a weather news link.

When the prior art STB is serving as an Internet module and a user wants to select a link, the user may move the cursor to the target link, or press the “Tab” function key to control the focus to move to the target link. Since the standard input device for most STB does not provide a convenient method to control the cursor, therefore, the user usually uses the “Tab” function key to control the focus to move to the target link. Please note that the focus is usually invisible, but the user can know focus location because the link or the function button will be “highlighted” when the focus moves there. However, when the user wants to move the focus to the target link where the location is in a different sub-window from that of the current focus, the user has to move the focus from the current link through to the last link of the current sub-window. Not only that, if the target link is not the first link of the target sub-window, the user has to move the focus from the first link to the target link of the target sub-window. Therefore, it is far from convenient.

Therefore, there is a need to develop a more convenient method to move the focus within a window.

### SUMMARY OF THE INVENTION

The object of the present invention is to provide an easy-to-use operating interface for a user. The user can use directional buttons (e.g. the left key, the right key, the up key the down key) to intuitionally move the focus within the window/sub-window so as to simplify the procedure of website surfing.

With regard to this objective, a method of using input device directional buttons to move the focus within the window is disclosed according to the one embodiment of the present invention. Wherein, the window comprises a plurality of sub-windows, and at least one sub-window comprises a plurality of links. The method according to the present invention comprises the following steps:

step A: receiving an up button, down button, left button or right directional button signal pressed by the user;

step B: determining if there is a link along the directional button path pressed by the user, if yes, then move the focus to the link, if no, then proceed to step C;

step C: determining if there is any content along the directional button path pressed by the user, if yes, then scroll the active sub-window along the directional button path, if no, then proceed to step D; and

step D: determining if there is a sub-window along the directional button path pressed by the user, if yes, then move the focus to the sub-window.

The present invention further provides a set top box for receiving networking signals to link to a website and outputting an image signal to a television, and a user may view the content of the website via the television.

The set top box provides an input device for the user to control the focus movement within the window. The characteristic of the present invention is that the set top box provides an input device so that the user can intuitionally move the focus within a window, wherein the input device comprises four directional buttons: an up button, a down button, a left button and a right button, wherein the window comprises a plurality of sub-windows, and at least one sub-window comprises a plurality of links.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of the environment according to the present invention.

FIG. 2 is the hardware structure of a set top box.

FIG. 3 is a flowchart of an embodiment of the present invention.

FIG. 4 is a first drawing of a series of screen displays on a television of the embodiment according to the present invention.

FIG. 5 is a second drawing of a series of screen displays on a television of the embodiment according to the present invention.

### DETAILED DESCRIPTION OF THE PREFERRED EMBODIMENT

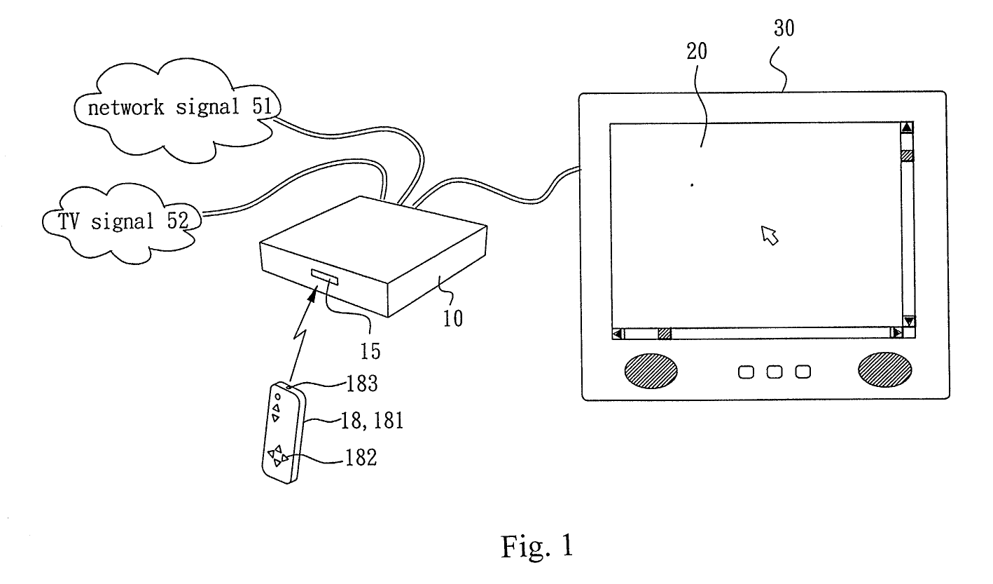

Please refer to FIG. 1. FIG. 1 is a schematic drawing of the environment according to the present invention. A set top box (STB) 10 is connected to a television 30 and able to receive a network signal 51 and a television signal 52. A user can watch TV programs and surf on the Internet via the television 30. An input device 18 with an infrared transmitter 183 is used for providing control instructions to the STB 10 infrared receiver 15. Generally, the input device 18 is a remote control 181 or a keyboard. As shown in FIG. 1, the remote control 181 includes a cursor directional button 182 and the infrared transmitter 183. The STB 10 infrared receiver 15 receives the infrared light sent by the infrared transmitter 183.

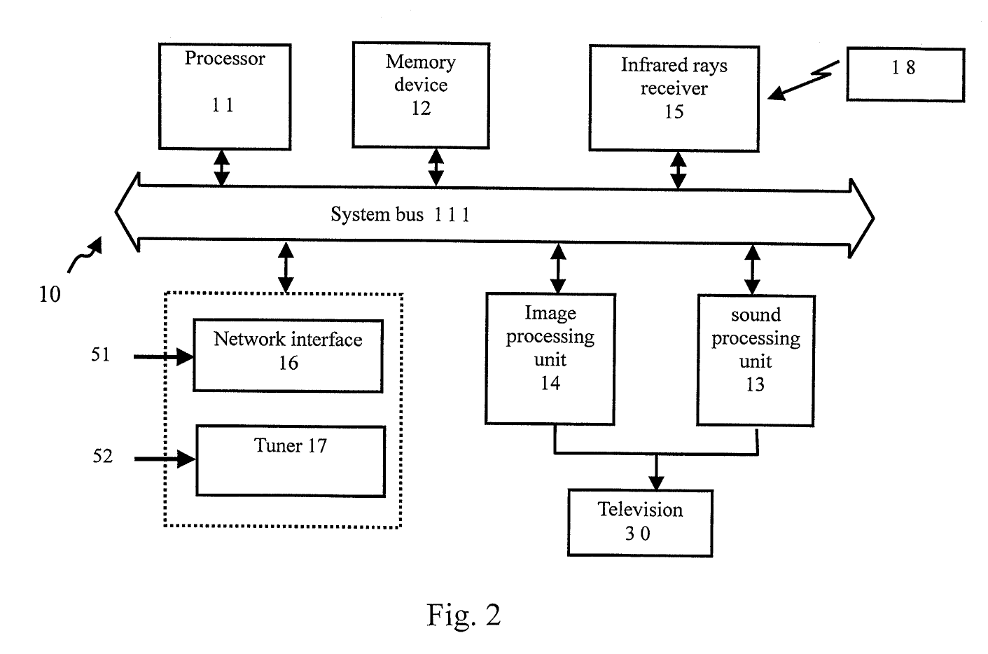

Please refer to FIG. 2. FIG. 2 illustrates the set top box hardware structure. Many STB 10 components are similar to those found in a typical computer. The STB 10 comprises a processor 11, a system bus 111, a memory device 12 (such as DRAM, a hard disk, a memory card), a sound processing unit 13, an image processing unit 14, the infrared receiver 15, a network interface 16, a tuner 17 and the input device 18. Networking signals 51 (such as from Internet) are received by the network interface 16, and the tuner 17 receives TV tuner signals 52. However, in some cases, both the network signals 51 and the TV signals 52 are sent to the STB 10 via an identical cable. Since the characteristics of the present invention are not concerned with the particular hardware characteristics of the STB 10, there will be no further description of the hardware and associated functionality of the STB 10.

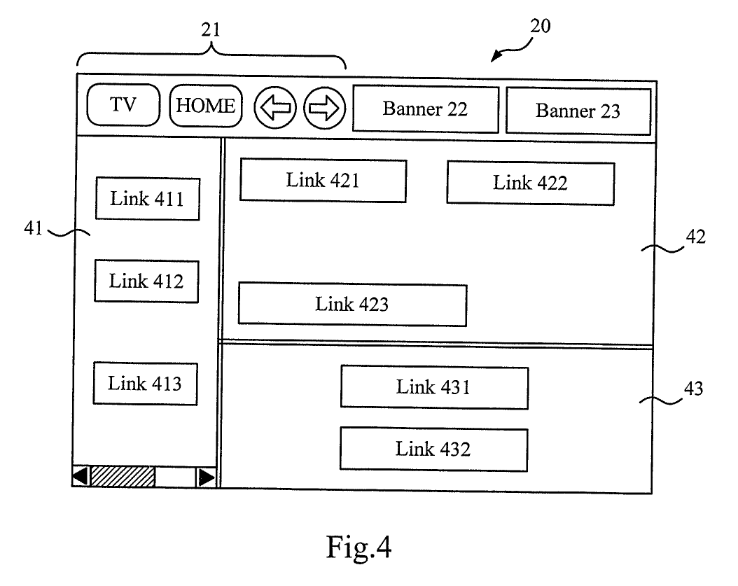

The characteristic of the present invention is to let the user intuitionally move the focus within a window via an input device 18. The input device 18 comprises four directional buttons 182: an up button, a down button, a left button and a right button. Please refer to FIG. 4. According to the embodiment, the window area 20 is divided into three sub-windows 41,42,43, and each sub-window comprises a plurality of links, such as links 411˜413, links 421˜423 and links 431˜432. Two banners 22,23 can also be arranged and displayed on the television 30 screen for advertisement purpose. When a user presses the directional button 182, the focus will accommodate the direction of the directional button pressed, then move to the link, move to the sub-window, or scroll the web page. For example, if the focus moves to the link, then the link will be highlighted so that a user can press the “Enter key” to connect to the web page to which the link directs. The web page shown on FIG. 4 according to the embodiment, is written by “Hypertext Markup Language (HTML)”, and therefore each set of tag <A></A> introduces a link, and each set of tag <frame></frame> introduces a sub-window.

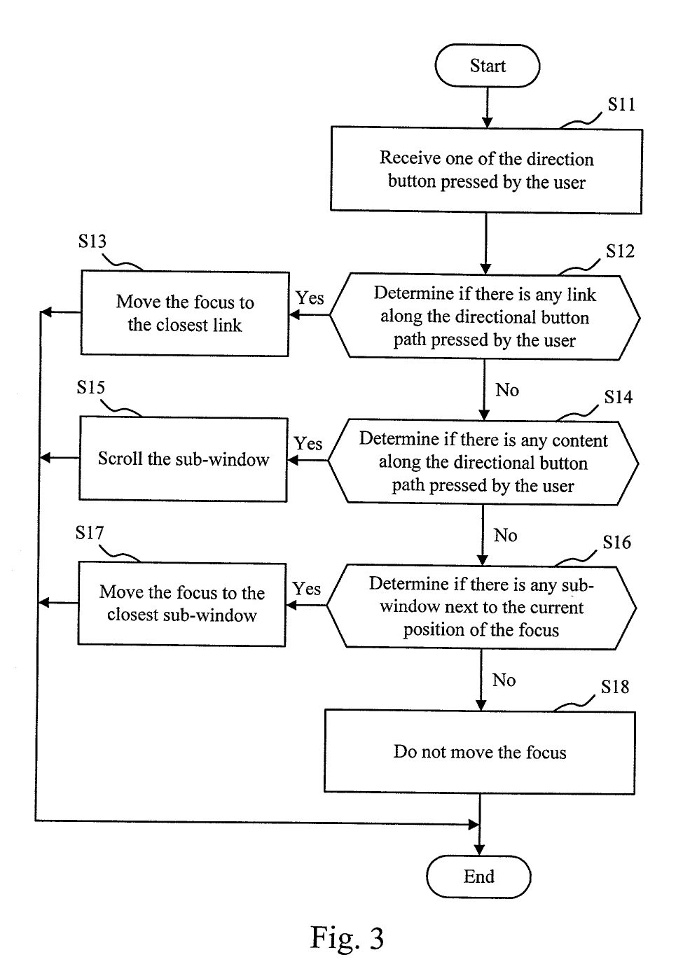

Please refer to FIG. 3. FIG. 3 is a flowchart of an embodiment of the present invention. First, the STB 10 receives an up button, down button, left button or right directional button 182 signal pressed by the user (Step 11). The signal is sent to the STB 10 infrared receiver 15 via the infrared transmitter 183, and is then processed by the STB 10. In the embodiment, the infrared transmitter 183 utilizes the Information Data Association (IDA) transmission standard and a PS2 interface to connect to the STB 10. The processor 11 converts a scan code transmitted from the infrared transmitter 183 to a key code, and the STB 10 controls focus movement on the screen according to the directional button 182 as manipulated by the user. The present invention need not, however, be limited to the above-mentioned input device.

After the directional button 182 is pressed, the set top box (STB) 10 determines if there is a link along the directional button path pressed by the user (Step 12). Please also refer to FIG. 4. For example, the focus is on the link 411 and the user press the “down” directional button 182. Therefore the STB 10 receives the “down” directional button 182 signal. Because the link 412 is below the link 411, the STB 10 moves the focus to the link 412 (Step 13). If the STB 10 receives the “down” directional button 182 signal again, the STB 10 will move the focus to the link 413.

However, when the focus is on the link 413, and the user presses the “down” directional button 182 again, since there is no link below the link 413, then the set top box (STB) 10 determines if there is any content along the direction of the directional button pressed by the user (Step 14). As shown in FIG. 4, since there is no content below the link 413, then the set top box (STB) 10 determines if there is a sub-window along the directional button path pressed by the user. Finally, since there is no sub-window below the link 413, the focus does not move and will stay at the link 413 (Step 18).

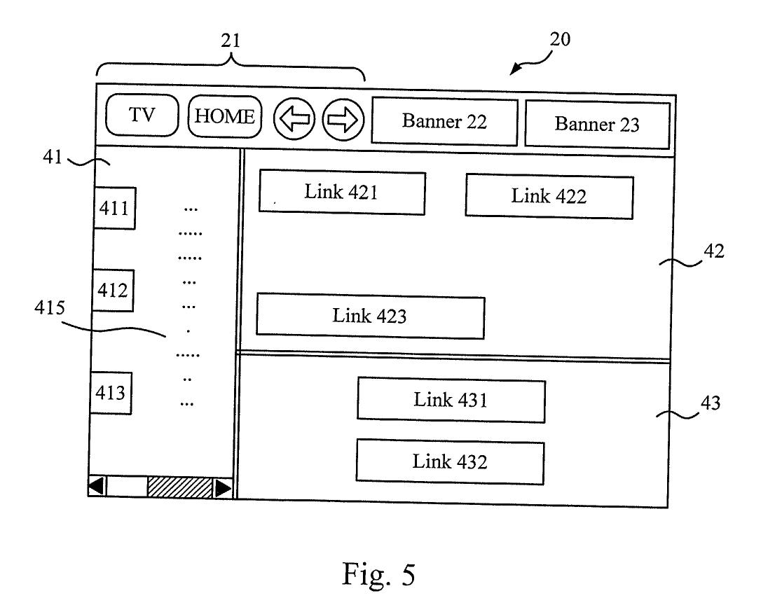

Please also refer to FIG. 5. If the user presses the “right” directional button 182 when the focus is on the link 413, the set top box (STB) 10 will determine, as mentioned as above, if there is a link, content, or sub-window along the directional button path pressed by the user. Because there is no link right next to the link 413 but there is content 415, the sub-window 41 will be scrolled rightward (Step 15) as shown in FIG. 5. In the present embodiment, the predetermined scroll distance for the display is half a page. However, the predetermined scroll distance could vary.

Suppose the “right” directional button 182 is pressed again, since there is no content on the sub-window's 41 right side, then the set top box (STB) 10 will determine if there is a sub-window right next to the current position of the focus (Step 16). As shown in FIG. 5, the closest sub-window right next to the link 413 is the sub-window 43, so the focus moves to the link 431 of the sub-window 43 (Step 17).

Please note that, according to the embodiment discussed above, the focus will move to the closest link of the current position of the focus when the focus moves to other sub-windows, so the focus moves to the link 431 of the sub-window 43. However, the next position of the focus could be pre-determined in a different way, such as the focus moves to the top most left link of the sub-window, or moves to the middle of the sub-window.

Please refer to FIG. 4 and FIG. 5 again for more examples explained as follows:

When the focus is on the link 412 and the “right” directional button 182 is pressed, the sub-window 41 will be scrolled rightward to show the content 415. Once the “right” directional button 182 is pressed again, the focus will move to the sub-window 42 and stay at the link 423 that is the closed link of the sub-window 42 next to the link 412.

Suppose the focus is on the link 411 and the “right” directional button 182 is pressed, the sub-window 41 will also be scrolled rightward to show the content 415. Once the “right” directional button 182 is pressed again, the focus will move to the sub-window 42 and stay at the link 421 that is the closed link of the sub-window 42 next to the link 411.

Suppose the focus is on the link 432 and the “up” directional button 182 is pressed, the focus will move to the link 431. Once the “up” directional button 182 is pressed again, the focus will move to the sub-window 42 and stay at the link 423 which is the closed link of the sub-window 42 next to the link 431.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

What is claimed is:

1. A method of intuitionally moving the focus within a window to let a user use an input device to intuitionally move the focus, wherein the input device comprises four directional buttons: an up button, a down button, a left button and a right button, wherein the window comprises a plurality of sub-windows, and at least one sub-window comprises a plurality of links, the method comprising the steps of:
step A: receiving an up button, down button, left button or right directional button 182 signal pressed by the user;
step B: determining if there is a link along the directional button path pressed by the user, if yes, then move the focus to the link, if no, then proceed to step C;
step C: determining if there is any content along the directional button path pressed by the user, if yes, then scrolling the active sub-window along the direction of the directional button, if no, then proceed to step D; and
step D: determining if there is a sub-window along the directional button path pressed by the user, if yes, then move the focus to the sub-window.

2. The method as claimed in claim 1, in the step D, if the sub-window to which the focus moves has at least one link, then the focus moves to one of the link(s) of the sub-window.

3. The method as claimed in claim 1, in the step D, if the sub-window to which the focus moves has at least one link, then the focus moves to the top most left link of the sub-window.

4. The method as claimed in claim 1, in the step D, if the sub-window to which the focus moves has at least one link, then the focus moves to the closest link of the sub-window.

5. The method as claimed in claim 1, in the step D, if there is no sub-window along the directional button path pressed by the user, if yes, then the focus will not move.

6. A set top box for receiving network signals to link to a website and outputting an image signal to a television, a user capable of viewing website content via the television, the set top box providing an input device so that the user can intuitionally move the focus within a window, wherein the input device comprises four directional buttons: an up button, a down button, a left button and a right button, wherein the window comprises a plurality of sub-windows, and at least one sub-window comprises a plurality of links, the set top box comprising:
a processor;
a memory, coupled to said processor; and
a first sequence of instructions, which, when executed by said processor, causes said processor to perform the steps of:
step A: receiving an up button, down button, left button or right directional button 182 signal pressed by the user;
step B: determining if there is a link along the directional button path pressed by the user, if yes, then move the focus to the link, if no, then proceed to step C;
step C: determining if there is any content along the directional button path pressed by the user, if yes, then scrolling the active sub-window along the direction of the directional button, if no, then proceed to step D; and
step D: determining if there is a sub-window along the directional button path of the directional button pressed by the user, if yes, then move the focus to the sub-window.

7. The set top box as claimed in claim 6, in the step D, if the sub-window to which the focus moves has at least one link, then the focus moves to one of link(s) of the sub-window.

8. The set top box as claimed in claim 6, in the step D, if the sub-window to which the focus moves has at least one link, then the focus moves to the top most left link of the sub-window.

9. The set top box as claimed in claim 6, in the step D; if the sub-window to which the focus moves has at least one link, then the focus moves to the closest link of the sub-window.

10. The set top box as claimed in claim 6, in the step D, if there is no sub-window along the directional button path pressed by the user, if yes, then the focus will not move.
